(19) United States
(12) Patent Application Publication
(10) Pub. No.: US 2004/0254787 A1
(43) Pub. Date: Dec. 16, 2004

(54) System and method for distributed speech recognition with a cache feature

(76) Inventors: Sheetal R. Shah, Cupertino, CA (US); Pratik Desai, Boca Raton, FL (US); Philip A. Schentrup, Hollywood, FL (US)

Correspondence Address: Scott M. Garrett, Motorola, Inc., Law Department, 8000 West Sunrise Boulevard, Fort Lauderdale, FL, 33322, US

(21) Appl. No.: 10/460,141

(22) Filed: Jun. 12, 2003

(51) Int. Cl. G10L 19/10; G10L 19/08

(52) U.S. Cl. 704/219

(57) ABSTRACT

The invention equips a cellular telephone or other communications device with improved voice recognition and command capability. A cellular handset may be equipped with a digital signal processing or other hardware to enhance speech detection and command decoding, but still be relatively constrained in terms of the amount of electronic memory or other storage available on the device, or the processing power or battery life offered by the device. In embodiments, the cellular handset or other device may perform a first-stage decoding of a voice or other command, for instance to perform a voice browsing function over the Internet or a directory. The handset may perform a look-up of the detected command or service against a local memory cache of stored commands, services and models and if a match is found, proceed directly to performing the desired service. If a match is not found in the device memory, the voice signal may be communicated to a server or other resource in the cellular or other network, for remote or distributed decoding of the command or action. When that service is returned to the handset, the service along with the associated model may be stored into electronic memory or other storage for future access, in caching fashion. A user's most frequently used, or latest used, commands and services may be locally stored on the device, for instance, enabling prompt response times within those commands or services.

### FIELD OF THE INVENTION

The invention relates to the field of human/user interfaces, and more particularly to distributed voice recognition systems in which a mobile unit, such as a cellular telephone or other device, stores speech-recognized models for voice or other services on the portable device.

### BACKGROUND OF THE INVENTION

Many cellular telephones and other communications devices now have the capability to decode and respond to voice commands. Applications for these speech-enabled devices have been suggested include voice browsing on the Internet, for instance using VoiceXML or other enabling technologies, voice-activated dialing or other directory applications, voice-to-text or text-to-voice messaging and retrieval, and others. Many cellular handsets, for instance, are equipped with embedded digital signal processing (DSP) chips which may enhance voice detection algorithms and other functions.

The usefulness and convenience of these speech-enabled technologies to users are affected by a variety of factors, including the accuracy with which speech is decoded as well as the response time of the speech detection and the lag time for the retrieval of services selected by the user. With regard to speech detection itself, while many cellular handsets and other devices may contain sufficient DSP and other processing power to analyze and identify speech components, robust speech detection algorithms may involve or require complex models which demand significant amounts of processing power, battery life (due to computational demands), memory or storage to most efficiently identify speech components and commands. Cellular handsets may not typically be equipped with enough random access memory (RAM), for example, to fully exploit those types of speech routines.

Partly as a result of these considerations, some cellular platforms have been proposed or implemented in which part or all of the speech detection activity and related processing may be offloaded to the network, specifically to a network server or other hardware in communication with the mobile handset. An example of that type of network architecture is illustrated in FIG. 1. As shown in that figure, a microphone-equipped handset may decode and extract speech phonemes and other components, and communicate those components to a network via a wireless link. Once the speech feature vector is received on the network side, a server or other resources may retrieve voice, command and service models from memory and compare the received feature vector against those models to determine if a match is found, for instance a request to perform a lookup of a telephone number.

If a match is found, the network may classify the voice, command and service model according to that hit, for instance to retrieve a public telephone number from a LDAP or other database. The results may then be communicated back to the handset or other communications device to be presented to the user, for instance audibly, as in a voice menu or message, or visibly, for instance on a text message on a display screen.

While a distributed recognition system may enlarge the number and type of voice, command and service models that may be supported, there are drawbacks to such an architecture. Networks hosting such services, and which process every command, may consume a significant amount of available wireless bandwidth processing such data. Those networks may be more expensive to implement.

Moreover, even with comparatively high-capacity wireless links from the mobile unit into the network, a degree of lag time between the user's spoken command and the availability of the desired service on the handset may be inevitable. Other problems exist.

### SUMMARY OF THE INVENTION

The invention overcoming these and other problems in the art relates in one regard to a system and method for distributed speech recognition with a cache feature, in which a cellular handset of other communications device may be equipped to perform first-stage feature extraction and decoding on voice signals spoken into the handset. In embodiments, the communications device may store the last ten, twenty or other number of voice, command or service models accessed by the user in memory in the handset itself. When a new voice command is identified, that command and associated model may be checked against the cache of models in memory. When a hit is found, processing may proceed directly to the desired service, such as voice browsing or others, based on local data. When a hit is not found, the device may communication the extracted speech features to the network for distributed or remote decoding and the generation of associated models, which may be returned to the handset to present to the user. Most recent, most frequent or other queuing rules may be used to store newly accessed models in the handset, for instance dropping the most outdated model or service from local memory.

### BRIEF DESCRIPTION OF THE DRAWINGS

The invention will be described with reference to the accompanying drawings, in which like elements are referenced with like numbers, and in which:

FIG. 1 illustrates a distributed voice recognition architecture, according to a conventional embodiment.

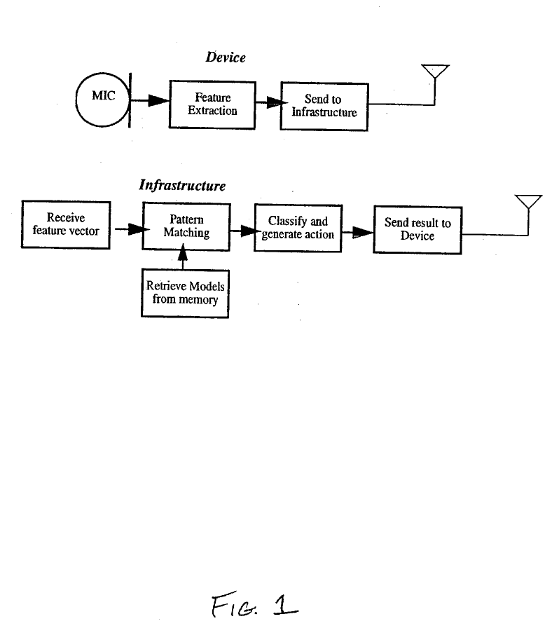

FIG. 2 illustrates an architecture in which a distributed speech recognition system with a cache feature may operate, according to an embodiment of the invention.

FIG. 3 illustrates an illustrative data structure for a network model store, according to an embodiment of the invention.

FIG. 4 illustrates a flowchart of overall voice recognition processing, according to an embodiment of the invention.

### DETAILED DESCRIPTION OF EMBODIMENTS

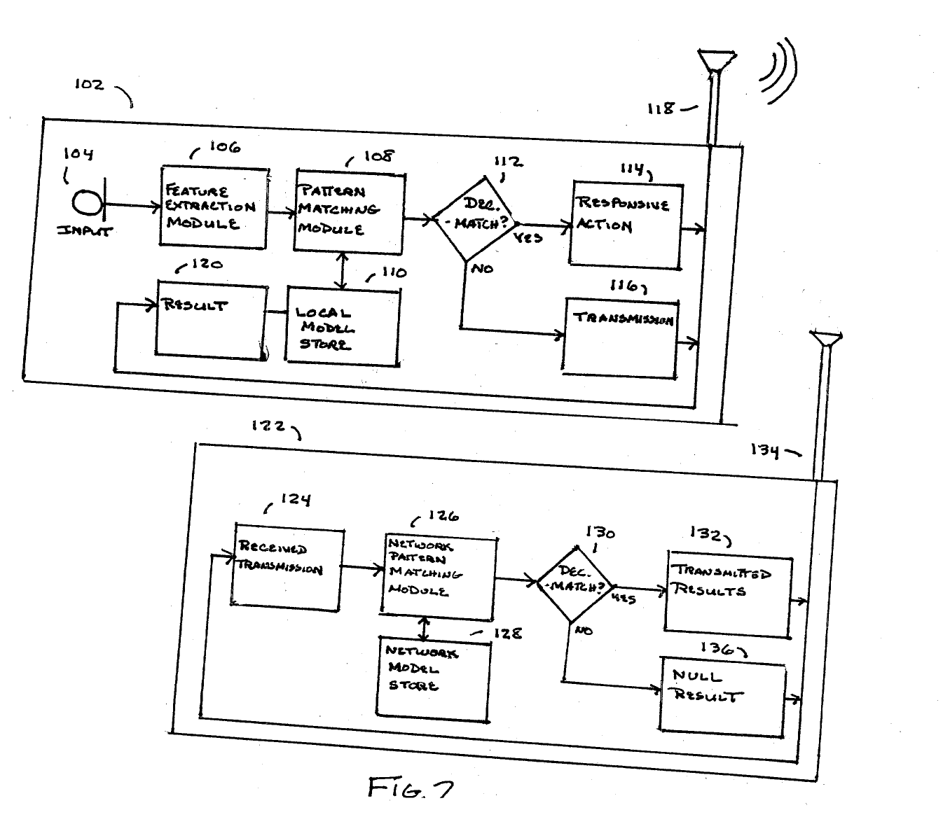

FIG. 2 illustrates a communications architecture according to an embodiment of the invention, in which a communications device 102 may wirelessly communicate with network 122 for voice, data and other communications purposes. Communications device 102 may be or include, for instance, a cellular telephone, a network-enabled wireless device such as a personal digital assistant (PDA) or personal information manager (PIM) equipped with an IEEE 802.11b or other wireless interface, a laptop or other portable computer equipped with an 802.11b or other wireless interface, or in embodiments other wired, optical or wireless communications or client devices. Communications device 102 may communicate with network 122 via antenna 118, for instance in the 800/900 MHz, 1.9 GHz, 2.4 GHz or other frequency bands, or in embodiments by other wired, optical or wireless links.

Communications device 102 may include an input device 104, for instance a microphone, to receive voice input from a user. Voice signals may be processed by a feature extraction module 106 to isolate and identify speech components, suppress noise and perform other signal processing or other functions. Feature extraction module 106 may in embodiments be or include, for instance, a microprocessor or DSP or other chip, programmed to perform speech detection and other routines. For instance, feature extraction module 106 may identify discrete speech components or commands, such as “yes”, “no”, “dial”, “email”, “home page”, “browse” and others.

Once a speech command or other component is identified, feature extraction module 106 may communicate one or more feature vector or other voice components to a pattern matching module 108. Pattern matching module 108 may likewise include a microprocessor, DSP or other chip to process data including the matching of voice components to known models, such as voice, command, service or other models. In embodiments, pattern matching module 108 may be or include a thread or other process executing on the same microprocessor, DSP or other chip as feature extraction module 106.

When a voice component is received in pattern matching module 108, that module may check that component against local model store 110 at decision point 112 to determine whether a match may be found against a set of stored voice, command, service or other models.

Local model store 110 may be or include, for instance, non-volatile electronic memory such as electrically programmable memory or other media. Local model store 110 may contain a set of voice, command, service or other models for retrieval directly from that media in the communications device. In embodiments, the local model store 110 may be initialized using a downloadable set of standard models or services, for instance when communications device 102 is first used or is reset. In embodiments, the local model store 110 may also be programmed by a vendor at the factory or other source, trained by a user, left initially empty, or otherwise initialized.

When a match is found in the local model store 110 for a voice command such as, for example, “home page”, an address such as a universal resource locator (URL) or other address or data corresponding to the user's home page, such as via an Internet service provider (ISP) or cellular network provider, may be looked up in table or other format to classify and generate a responsive action 114. In embodiments, responsive action 114 may be or include, for instance, linking to the user's home page or other selection resource or service from the communications device 102. Further commands or options may then be received via input device 104. In embodiments, responsive action 114 may be or include presenting the user with a set of selectable voice menu options, via VoiceXML or other protocols, screen displays if available, or other formats or interfaces during the use of an accessed resource or service. If at decision point 112 a match against local model store 110 is not found, communications device 102 may initiate a transmission 116 to network 122 for further processing. Transmission 116 may be or include the sampled voice components separated by feature extraction module 106, received in the network 122 via antenna 134 or other interface or channel. The received transmission 124 so received may be or include feature vectors or other voice or other components, which may be communicated to a network pattern matching module 126 in network 122.

Network pattern matching module 126, like pattern matching model 108, may likewise include a microprocessor, DSP or other chip to process data including the matching of a received feature vector or other voice components to known models, such as voice, command, service or other models. In the case of pattern matching executed in network 122, the received feature vector or other data may be compared against a stored set of voice-related models, in this instance network model store 128. Like local model store 110, network model store 128 may be or include may contain a set of voice, command, service or other models for retrieval and comparison to the voice or other data contained in received transmission 124.

At decision point 130, a determination may be made whether a match is found between the feature vector or other data contained in received transmission 124 and network model store 128. If a match is found, transmitted results 132 may be communicated to communications device 102 via antenna 134 or other channels. Transmitted results 132 may include a model or models for voice, commands, or other service corresponding to the decoded feature vector or other data. The transmitted results 132 may be received in the communications device 102 via antenna 118, as network results 120. Communications device 102 may then execute one or more actions based on the network results 120. For instance, communications device 102 may link to an Internet or other network site. In embodiments, at that site the user may be presented with selectable options or other data. The network results 120 may also be communicated to the local model store 110 to be stored in communications device 102 itself.

In embodiments, the communications device 102 may store the models or other data contained in network results 120 in non-volatile electronic or other media. In embodiments, any storage media in communications device 102 may receive and store network results into the local model store 110 based on queuing or cache-type rules, for instance when electronic or other media are full. Those rules may include, for example, rules such as dropping the least-recently used model from local model store 110 to be replaced by the new network results 120, dropping the least-frequently used model from local model store 110 to be similarly replaced, or by following other rules or algorithms to retain desired models within the storage constraints of communications device 102.

In instances where at decision point 130 no match is found between the feature vector or other data of received transmission 124 and network model store 128, a null result 136 may be transmitted to communications device 102 indicating that no model or associated service could be identified corresponding to the voice signal. In embodiments, in that case communications device 102 may present the user with an audible or other notification that no action was taken, such as “We're sorry, your response was not understood” or other announcement. In that case, the communications device 102 may received further input from the user via input device 104 or otherwise, to attempt to access the desired service again, access other services or take other action.

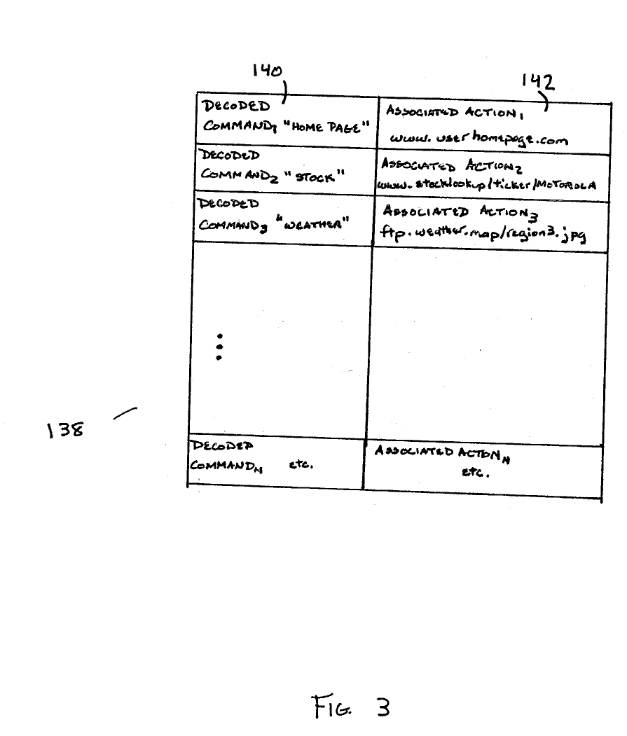

FIG. 3 shows an illustrative data construct for network model store 128, arranged in a table 138. As shown in that illustrative embodiment, a set of decoded commands 140 (DECODED COMMAND₁, DECODED COMMAND₂, DECODED COMMAND₃ . . . DECODED COMMAND_{N}, N arbitrary) corresponding to or contained within extracted features of voice input may be stored in a table whose rows may also contain a set of associated actions 142 (ASSOCIATED ACTION₁, ASSOCIATED ACTION₂, ASSOCIATED ACTION₃ . . . FIRSTACTION_{N}, N arbitrary). Additional actions may be stored for one or more of decoded commands 140.

In embodiments, the associated actions 142 may include, for example, an associated URL such as http://www.userhomepage.com corresponding to a “home page” or other command. A command such as “stock” may, illustratively, associate to a linking action such as a link to “http://www.stocklookup.com/ticker/Motorola” or other resource or service, depending on the user's existing subscriptions, their wireless or other provider, the database or other capabilities of network 122, and other factors. A decoded command of “weather” may link to a weather download site, for instance ftp.weather.map/region3.jp, or other file, location or information. Other actions are possible. Network model store 128 may in embodiments be editable and extensible, for instance by a network administrator, a user, or others so that given commands or other inputs may associate to differing services and resources, over time. The data of local model store 110 may be arranged similarly to network model store 128, or in embodiments the fields of local model store 110 may vary from those of network model store 128, depending on implementation.

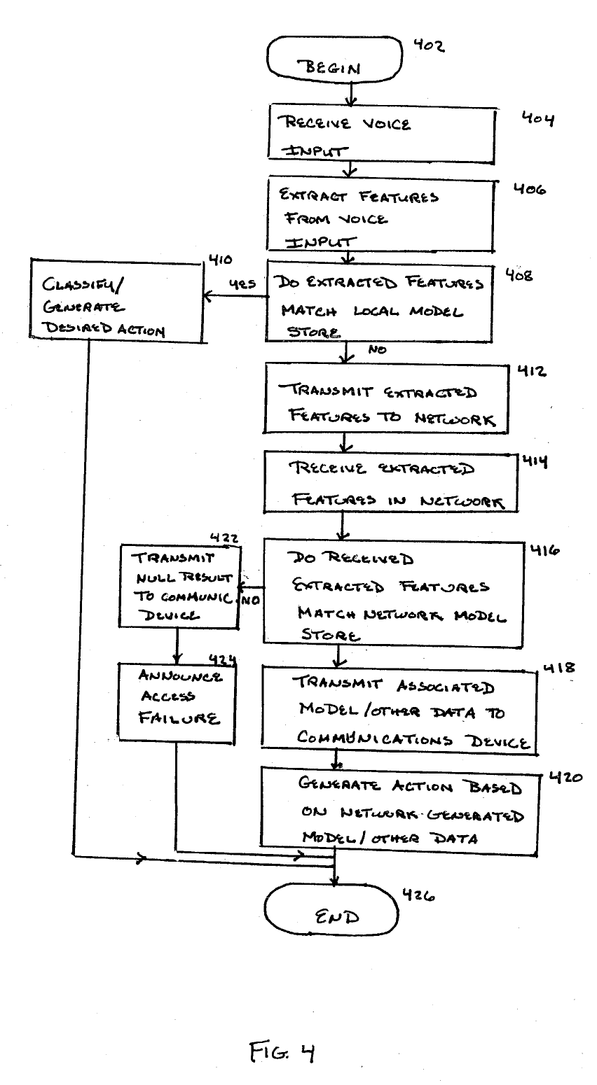

FIG. 4 shows a flowchart of distributed voice processing according to an embodiment of the invention. In step 402, processing begins. In step 404, communications device 102 may receive voice input from a user via input device 104 or otherwise. In step 406, the voice input may be decoded by feature extraction module 106, to generate a feature vector or other representation. In step 408, a determination may be made whether the feature vector or other representation of the voice input matches any model stored in local model store 110. If a match is found, in step 410 the communications device 102 may classify and generate the desired action, such as voice browsing or other service. After step 410, processing may proceed to step 426, in which the local model store 110 or information related thereto may be updated, for instance to update a count of number of times of use of a service, or update other data. After the local model store 110 may be updated as appropriate in step 426, processing may repeat, return to a prior step, terminate in step 428, or take other action.

If no match is found in step 408, in step 412 the feature vector or other extracted voice-related data may be transmitted to network 122. In step 414, the network may receive the feature vector or other data. In step 416, a determination may be made whether the feature vector or other representation of the voice input matches any model stored in network model store 128. If a match is found, in step 418 the network 122 may transmit the matching model, models or related data or service to the communications device 102. In step 420, the communications device 102 may generate an action based on the model, models or other data or service received from network 122, such as execute a voice browsing command or take other action. After step 420, processing may proceed to step 426, in which the local model store 110 or information related thereto may be updated, for instance to load a new model or service into local model store 110, update a count of number of times of use of a service, or update other data. After the local model store 110 may be updated as appropriate in step 426, processing may repeat, return to a prior step, terminate in step 428, or take other action.

If in step 416 a match is not found between the feature vector or other data received by network 122 and the network model store 128, processing may proceed to step 422 in which a null result may be transmitted to the communications device. In step 424, the communications device may present an announcement to the user that the desired service or resource could not be accessed. After step 424, processing may repeat, return to a prior step, terminate in step 428 or take other action.

The foregoing description of the system and method for distributed speech recognition with a cache feature according to the invention is illustrative, and variations in configuration and implementation will occur to persons skilled in the art. For instance, while the invention has generally been described as being implemented in terms of embodiments employing a wireless handset as communications device 102, in embodiments other input or client devices may be used. For example, communications device 102 may in embodiments be or include a corded or wired telephone or other handset or headset, a handset or headset connected to a computer configured for Internet Protocol (IP) telephony, or other wired, optical or wireless devices.

Similarly, while the invention has generally been described in terms of a single feature extraction module 106, single pattern matching module 108 and network pattern matching module 126, in embodiments one or more of those modules may be implemented in multiple modules or other distributed resources. Similarly, while the invention has generally been described as decoding live speech input to retrieve models and services in real time or near-real time, in embodiments the speech decoding function may be performed on stored speech, for instance on a delayed, stored, or offline basis.

Likewise, while the invention has been generally described in terms of a single communications device 102, in embodiments the models stored in local model store 110 may be shared or replicated across multiple communications devices, which in embodiments may be synced for model currency regardless of which device was most recently used. Further, while the invention has been described as queuing or caching voice inputs and associated models and services for a single user, in embodiments the local model store 110, network model store 128 and other resources may consolidate accesses by multiple users. The scope of the invention is accordingly intended to be limited only by the following claims.

We claim:

1. A system for decoding speech to access services via a communications device, comprising:
an input device for receiving speech input;
a feature extraction engine, the feature extraction engine extracting at least one feature from the speech input;
a local model store;
a first interface to a network, the network comprising a network model store, the network model store being configured to generate at least one service depending on the at least one feature extracted from the speech input; and
a processor, communicating with the input device, the feature extraction engine, the local model store and the first interface, the processor testing the at least one feature extracted from the speech input against the local model store to act upon a service request, the processor being configured to initiate a transmission of the at least one feature extracted from the speech input to the network via the first interface when no match is found between the local model store and the at least one feature extracted from the speech input.

2. A system according to claim 1, wherein the first interface comprises a wired interface.

3. A system according to claim 1, wherein the first interface comprises a wireless interface.

4. A system according to claim 1, wherein the first interface comprises an optical interface.

5. A system according to claim 1, wherein the processor initiates a transmission of the at least one feature extracted from the speech input to the network when a match between the at least one feature extracted from the speech input and the local model store is not found.

6. A system according to claim 5, wherein the network responds to the at least one feature extracted from the speech input to generate the at least one service and transmit the at least one service to the communications device.

7. A system according to claim 6, wherein the processor stores the at least one service in the local model store.

8. A system according to claim 7, wherein the processor deletes an obsolete service upon the storing of the at least one service in the local model store when the local model store is full.

9. A system according to claim 8, wherein the deleting of the obsolete service is performed on a least-recently used basis.

10. A system according to claim 8, wherein the deleting of the obsolete service is performed on a least-frequently used basis.

11. A system according to claim 1, wherein an local model store comprises an initializable local model store downloadable from the network, programmed by a vendor, or trained by a user.

12. A system according to claim 1, wherein the at least one service comprises at least one of voice browsing, voice-activated dialing and voice-activated directory service.

13. A system according to claim 1, wherein the processor initiates a service based on the local model store when a match between the speech input and the local model store is found.

14. A system according to claim 13, wherein the initiation comprises linking to a stored address.

15. A system according to claim 14, wherein the linking to a stored address comprises accessing a URL.

16. A method for decoding speech to access services via a communications device, comprising:
receiving speech input;
extracting at least one feature from the speech input;
testing the at least one feature extracted from the speech input against a local model store in a communication device to act upon a service request; and
when no match if found between the local model store and the at least one feature extracted from the speech input
transmitting the at least one feature extracted from the speech input via a first interface to a network, and
generating a link to at least one service depending on the at least one feature extracted from the speech input.

17. A method according to claim 16, further comprising a step of transmitting the link to the communications device.

18. A method according to claim 16, further comprising a step of storing the link in the local model store.

19. A method according to claim 18, further comprising a step of deleting an obsolete service upon the storing of the at least one service in the local model store when the local model store is full.

20. A method according to claim 19, wherein the deleting of the obsolete service is performed on a least recently-used basis.

21. A method according to claim 19, wherein the deleting of the obsolete service is performed on a least-frequently used basis.

22. A method according to claim 16, further comprising a step of initializing the local model store

23. A method according to claim 22, wherein the initializing comprises at least one of downloading an initializable local model store from the network to the communications device, programming by a vendor of the communications device, and training by a user of the communications device.

24. A method according to claim 16, wherein the at least one service comprises at least one of voice browsing, voice-activated dialing and voice-activated directory service.

25. A method according to claim 16, further comprising a step of initiating a service when a match between the at least one feature extracted from the speech input and the local model store is found.

26. A method according to claim 25, wherein the step of initiating comprises linking to a stored address.

27. A method according to claim 26, wherein the step of linking to a stored address comprises accessing a URL.

28. A communications system for decoding speech to access services via a communications device, comprising:
an input device for receiving speech input;
a feature extraction engine, the feature extraction engine extracting at least one feature from the speech input;
a local model store;
a first interface to a network;
a network, the network comprising a network model store, the network model store being configured to generate at least one service depending on the at least one feature extracted from the speech input; and
a processor, communicating with the input device, the feature extraction engine, the local model store and the first interface, the processor testing the at least one feature extracted from the speech input against the local model store to act upon a service request, the processor being configured to initiate a transmission of the at least one feature extracted from the speech input to the network via the first interface when no match is found between the local model store and the at least one feature extracted from the speech input.

29. A system according to claim 28, wherein the first interface comprises a wired interface.

30. A system according to claim 28, wherein the first interface comprises a wireless interface.

31. A system according to claim 28, wherein the first interface comprises an optical interface.

32. A system according to claim 28, wherein the processor initiates a transmission of the at least one feature extracted from the speech input to the network when a match between the at least one feature extracted from the speech input and the local model store is not found.

33. A system according to claim 32, wherein the network responds to the at least one feature extracted from the speech input to generate the at least one service and transmit the at least one service to the communications device.

34. A system according to claim 33, wherein the processor stores the at least one service in the local model store.

35. A system according to claim 34, wherein the processor deletes an obsolete service upon the storing of the at least one service in the local model store when the local model store is full.

36. A system according to claim 28, wherein the at least one service comprises at least one of voice browsing, voice-activated dialing and voice-activated directory service.

37. A system according to claim 28, wherein the processor initiates a service when a match between the speech input and the local model store is found.

38. A system according to claim 37, wherein the initiation comprises linking to a stored address.

39. A network system for decoding speech to access services inputted via a communications device, comprising:
a network model store, the network model store being configured to generate at least one service depending on at least one feature extracted from speech input to a communications device; and
a first interface to the communications device, the communications device comprising
an input device for receiving the speech input,
a feature extraction engine, the feature extraction engine extracting the at least one feature from the speech input,
a local model store, and
a processor, communicating with the input device, the feature extraction engine, the local model store and the first interface; and
a network processor, the network processor being configured to test the at least one feature extracted from the speech input against the network model store to act upon a service request, the network processor being configured to initiate a transmission of the at least one service to the communications device.

40. A system according to claim 39, wherein the first interface comprises a wired interface.

41. A system according to claim 39, wherein the first interface comprises a wireless interface.

42. A system according to claim 39, wherein the first interface comprises an optical interface.

43. A system according to claim 39, wherein the network processor responds to the at least one feature extracted from the speech input to generate the at least one service and transmit the at least one service to the communications device.

44. A system according to claim 43, wherein the processor in the communications device stores the at least one service in the local model store.

45. A system according to claim 44, wherein the processor in the communications device deletes an obsolete service upon the storing of the at least one service in the local model store when the local model store is full.

46. A system according to claim 39, wherein the at least one service comprises at least one of voice browsing, voice-activated dialing and voice-activated directory service.

47. A system according to claim 39, wherein the processor in the communications device initiates the at least one service upon receipt of the at least one service from the network.

48. A system according to claim 47, wherein the initiation comprises linking to a stored address.

49. A system for decoding speech to access services via a communications device, comprising:
input means for receiving speech input;
feature extraction means, the feature extraction means extracting at least one feature from the speech input;
local model store means;
first interface means to a wireless network, the network comprising network model store means, the network model store means being configured to generate at least one service depending on the at least one feature extracted from the speech input; and
processor means, communicating with the input means, the feature extraction means, the local model store means and the first interface means, the processor means testing the at least one feature extracted from the speech input against the local model store means to act upon a service request, the processor means being configured to initiate a transmission of the at least one feature extracted from the speech input to the network via the first interface means when no match is found between the local model store means and the at least one feature extracted from the speech input.

50. A system according to claim 49, wherein the first interface comprises a wired interface.

51. A system according to claim 49, wherein the first interface comprises a wireless interface.

52. A system according to claim 49, wherein the first interface comprises an optical interface.

53. A system according to claim 49, wherein the processor means initiates a transmission of the at least one feature extracted from the speech input to the network when a match between the at least one feature extracted from the speech input and the local model store means is not found.

54. A system according to claim 49, wherein the network responds to the at least one feature extracted from the speech input to generate the at least one service and transmit the at least one service to the communications device.

55. A system according to claim 49, wherein the processor means stores the at least one service in the local model store means.

56. A system according to claim 49, wherein the processor means deletes an obsolete service upon the storing of the at least one service in the local model store means when the local model store means is full.

57. A system according to claim 49, wherein the at least one service comprises at least one of voice browsing, voice-activated dialing and voice-activated directory service.

58 A system according to claim 49, wherein the processor means initiates a service when a match between the speech input and the local model store means is found.

59. A system according to claim 58, wherein the initiation comprises linking to a stored address.
